(19) United States
(12) Patent Application Publication
(10) Pub. No.: US 2022/0228715 A1
(43) Pub. Date: Jul. 21, 2022

(54) LIGHTING DEVICE COMPRISING A LIGHT EMITTING FILAMENT

(71) Applicant: SIGNIFY HOLDING B.V., EINDHOVEN (NL)

(72) Inventors: TIES VAN BOMMEL, HORST (NL); JOHANNES PETRUS MARIA ANSEMS, HULSEL (NL); RIFAT ATA MUSTAFA HIKMET, EINDHOVEN (NL); PETER JOHANNES MARTINUS BUKKEMS, DEURNE (NL)

(21) Appl. No.: 17/614,658

(22) PCT Filed: May 25, 2020
(86) PCT No.: PCT/EP2020/064358

§ 371 Date: Nov. 29, 2021

(30) Foreign Application Priority Data
May 29, 2019 (EP) 19177293.8

(51) Int. Cl. F21K 9/232; F21K 9/68; F21V 7/00

(52) U.S. Cl. CPC F21K 9/232; F21Y 2115/10; F21V 7/005; F21K 9/68

(57) ABSTRACT

There is disclosed alighting device (8) comprising: at least one light-emitting filament comprising (12) a plurality of solid-state light sources (14); and an elongated reflector (9) arranged to reflect light emitted by the light-emitting filament (12), wherein the reflector (9) has a longitudinal groove (11) in which the light-emitting filament (12) is arranged such that the reflector (9) and the at least one light-emitting filament (12) extend longitudinally along a common path, and wherein said path is curved in three dimensions. A light bulb (5) comprising the lighting device (8) and a luminaire (1) comprising the lighting device (8) are also disclosed. The lighting device (8) can be produced cost-efficiently and adapted to conform well to a predetermined emission pattern.

### FIELD OF THE INVENTION

The present invention relates to a lighting device comprising a light-emitting filament based on solid-state lighting technology.

### BACKGROUND OF THE INVENTION

Light-emitting filaments based on solid-state lighting technology are used in a variety of lighting applications. An example is the light-emitting diode (LED) lamp disclosed in CN204554464U, which has a spiral-shaped LED filament mounted on a cylindrical or conical heat conducting mechanism. While the LED lamp disclosed CN204554464U, and similar lighting devices with LED filaments, are suitable for their intended use, there is currently much interest in further developing the use of light-emitting filaments in lighting applications. For example, it would be desirable to develop new solutions for providing lighting devices with different kinds of emission patterns.

### SUMMARY OF THE INVENTION

An object of the present invention is to provide an improved or alternative lighting device with one or more light-emitting filaments based on solid-state lighting technology.

According to a first aspect of the present invention, there is presented a lighting device comprising: at least one light-emitting flexible filament comprising an elongated carrier, a plurality of solid-state light sources mounted on the carrier, wherein each solid-state light source is configured to emit light from a light-emitting surface, and an encapsulant comprising a translucent material, wherein the encapsulant at least partially encloses the light-emitting surfaces of the solid-state light sources; and an elongated reflector arranged to reflect light emitted by the light-emitting filament, wherein the reflector is arranged as a free standing element and is provided with a longitudinal groove in which the light-emitting flexible filament is arranged such that the reflector acts as a support for the light-emitting flexible filament, and wherein the reflector and the at least one light-emitting filament extend longitudinally along a common path, and wherein said path is curved in three dimensions.

By “path” is here meant a geometrical line, and by the path being “curved in three dimensions” means that the path is curved so as not to lie in a flat, two-dimensional plane.

The present invention is based on the realization that using a light-emitting filament, which is curved in three-dimensional space and arranged in a groove of a reflector following the same path as the light-emitting filament, allows for the cost-effective and simple manufacture of a lighting device which emits light that conforms well to a predetermined emission pattern. This enables, for instance, significant mitigation of glare by the reduction of the intensity of the emitted light in specific directions, as required by the application. Conventional solutions for achieving a desired emission pattern, such as providing the lighting device with various types of light-reflecting or light-blocking screens or the like, are typically more complicated structurally, and hence to manufacture.

By using a flexible filament in combination with a reflector that is arranged as a free-standing element enables a filament lamp that is cheap, can have an improved light distribution and is versatile with respect to design and possibilities to the shape of the filament. By choosing a certain shape of the reflector element, the flexible filament can be wound around the groove of the reflector following the path of this groove over its longitudinal length. Here, the reflector is arranged to act as a support for the filament in said reflector. This has the advantage that the lighting device does not require a separate support structure for the filament that is mechanically connected to the reflector. Note that there is a distinction between the carrier of the filament on which the LEDs are mounted and that forms a flexible string of light-emitting elements, and the rigid support formed by the reflector for supporting the flexible filament.

The elongated carrier may be light transmissive, such as translucent or transparent. Thereby, the light-emitting filaments may be configured to emit light substantially omni-directionally about the longitudinal axis of the light-emitting filament.

Within the context of this application, a LED filament is understood to be for providing LED filament light and comprises a plurality of light emitting diodes (LEDs) arranged in a linear array. Preferably, the LED filament has a length L and a width W, wherein L>5W. The LED filament may be arranged in a straight configuration or in a non-straight configuration such as for example a curved configuration, a 2D/3D spiral or a helix. Preferably, the LEDs are arranged on an elongated carrier like for instance a substrate, that may be rigid (made from e.g. a polymer, glass, quartz, metal or sapphire) or flexible (e.g. made of a polymer or metal e.g. a film or foil).

In case the carrier comprises a first major surface and an opposite second major surface, the LEDs are arranged on at least one of these surfaces. The carrier may be reflective or light transmissive, such as translucent and preferably transparent.

The LED filament may comprise an encapsulant at least partly covering at least part of the plurality of LEDs. The encapsulant may also at least partly cover at least one of the first major or second major surface. The encapsulant may be a polymer material which may be flexible such as for example a silicone. Further, the LEDs may be arranged for emitting LED light e.g. of different colors or spectrums. The encapsulant may comprise a luminescent material that is configured to at least partly convert LED light into converted light. The luminescent material may be a phosphor such as an inorganic phosphor and/or quantum dots or rods.

The LED filament may comprise multiple sub-filaments.

The lighting device may have a longitudinal axis, and the lighting device may be adapted to emit light rotationally symmetrically with respect to the longitudinal axis. The longitudinal axis of the lighting device is a geometrical axis.

The path may have at least one of a spiral shape and a meander shape. An example of a spiral is a helix. The path may a spiral shape with a central axis extending along said longitudinal axis. It should be noted that different sections of the path may have different shapes. For example, the path may have a section which is spiral-shaped and another section which is meander-shaped. The spiral shape may have at least three loops, alternatively at least four loops or at least five loops. The meander shape may have at least three turns, alternatively at least four turns or at least five turns. Increasing the number of loops or turns helps to improve the light distribution.

The groove may be arranged in a side of the reflector facing away from the longitudinal axis, whereby the reflector is adapted to promote light emission away from the longitudinal axis. This implies that at least a part of the reflector is arranged radially between the light-emitting filament and the longitudinal axis.

The groove may have a transverse cross section which is one of U-shaped, V-shaped, parabolic, circular and a combination thereof, or another suitable shape. The transverse cross section or the groove may vary along the length of the reflector. For example, some parts of the cross section may be U-shaped and others may be V-shaped. By “a transverse cross section” is meant a cross section that is perpendicular to the longitudinal extension of the reflector. Two legs of the cross section may have different lengths, whereby the reflector is adapted to promote light emission in a direction away from the longer leg. The cross section may be open towards a direction which is non-perpendicular to the longitudinal axis, whereby the reflector is adapted to promote light emission in that direction. It is noted that the length and/or shape of the legs may vary along the length of the reflector, such as from long to short, or vice versa.

The reflector may have a first longitudinal section adapted to promote light emission in a first direction, and a second longitudinal section adapted to promote light emission in a second direction different from the first direction. For example, the first direction may be parallel to the longitudinal axis, and the second direction may be perpendicular to the longitudinal axis. As another example, the first direction may be parallel to the longitudinal axis, and the second direction may be opposite to the first direction.

A side of the reflector facing the longitudinal axis may be provided with a low-reflective coating, such as a black coating.

The lighting device may comprise two light-emitting filaments and two reflectors, and the lighting device may further comprise a controller configured to independently control the light emitted by the two light-emitting filaments. The two light-emitting filaments may be configured to emit light of the same type. Alternatively, the two light-emitting filaments may be configured to emit light which differs in color, color temperature and/or some other characteristic.

According to a second aspect of the present invention, there is presented a light bulb comprising: at least one lighting device according to the first aspect of the present invention; a light-transmissive envelope enclosing the at least one lighting device; and a connector configured to mechanically and electrically connect the light bulb to a lightbulb socket.

According to a third aspect of the present invention, there is presented a luminaire comprising: at least one lighting device according to the first aspect of the present invention; and a connection configured to supply power to the at least one lighting device.

It is noted that the effects and features of the second and third aspects of the present invention are largely analogous to those described in connection with the first aspect of the present invention. It is also noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 schematically shows a perspective view of a luminaire according to an embodiment of the present invention.

FIG. 2 schematically shows a side view of a light bulb according to an embodiment of the present invention.

FIG. 3 schematically shows a side view of a lighting device according to an embodiment of the present invention.

FIG. 4 schematically shows a transverse cross-sectional view of a reflector.

FIG. 5 schematically shows a schematic perspective view of a light-emitting filament in a pre-bent state.

FIG. 6 schematically shows a schematic light distribution diagram.

FIG. 7 schematically shows a transverse cross-sectional view of a reflector.

FIG. 8 schematically shows a schematic light distribution diagram.

FIG. 9 schematically shows a schematic light distribution diagram.

FIG. 10 schematically shows a schematic light distribution diagram.

FIG. 11 schematically shows a side view of a lighting device according to an embodiment of the present invention.

FIG. 12 schematically shows a top view of the lighting device in FIG. 9.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. The present invention may, however, be embodied in many different forms and should not be construed as limited to the embodiments set forth herein; rather, these embodiments are provided for thoroughness and completeness, and fully convey the scope of the present invention to the skilled person.

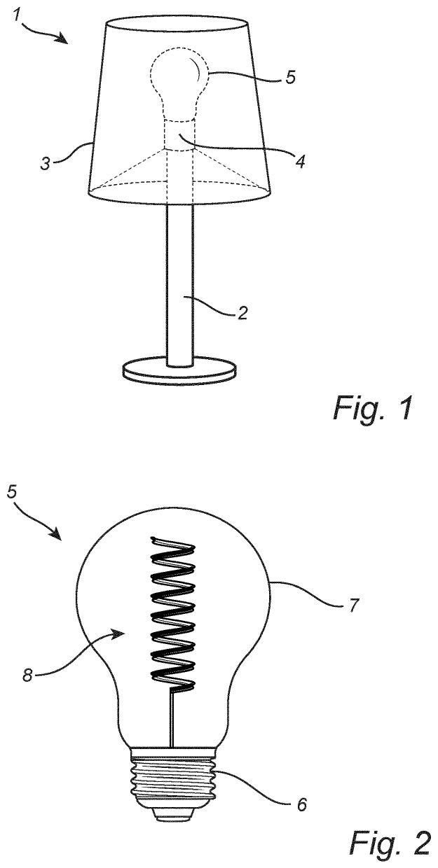

FIG. 1 shows an example of a luminaire 1. The luminaire 1 illustrated in FIG. 1 is a table lamp. The luminaire 1 may be of a different type in a different example, such as a wall-mounted or ceiling-mounted luminaire, and the luminaire may be intended for outdoor illumination instead of indoor illumination like the table lamp in FIG. 1. The luminaire 1 here comprises a base 2, a screen 3 and a connection 4 which in this case is a lightbulb socket. The luminaire 1 further comprises a light bulb 5 mounted to the connection 4 which is connected to supply power, here electricity from the mains, to the light bulb 5.

FIG. 2 shows the light bulb 5 in more detail. The light bulb 5 is in this case a retrofit light bulb, i.e. a light bulb designed to be retrofitted into a traditional type of lightbulb socket. The light bulb 5 comprises a connector 6 configured to mechanically and electrically connect the light bulb 5 to a lightbulb socket. In this case, the connector 6 includes an Edison screw base, but the connector 6 may be of a different type in a different example, such as a bayonet connector. The light bulb 5 further comprises a light-transmissive envelope 7. The envelope 7 can, for example, can be made of a plastic material or glass. The envelope 7 has a pear-like shape, although it may a different shape in a different example. A lighting device 8 is enclosed by the envelope 7, and the lighting device 8 will now be described in more detail below.

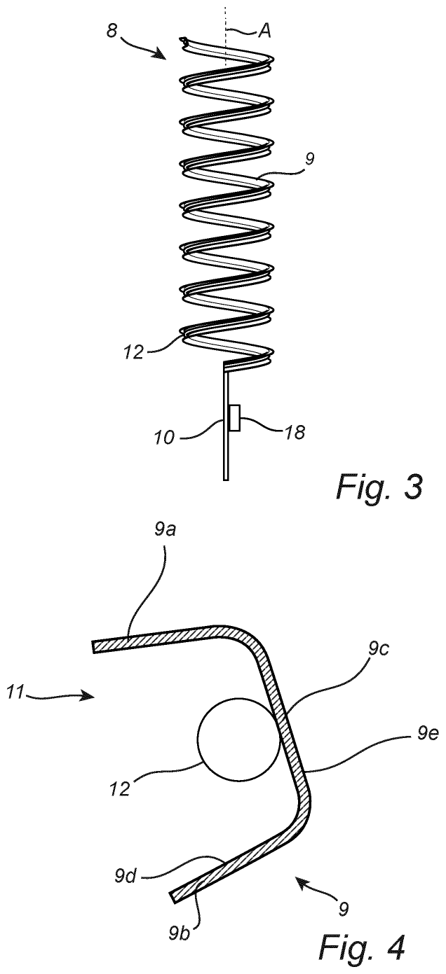

As illustrated in FIG. 3, the lighting device 8 here comprises a longitudinal axis A and an elongated reflector 9. The lighting device 8 is in this case mounted to the luminaire 1 such that the longitudinal axis A is parallel with the vertical up and down directions, but the longitudinal axis A may be arranged differently in a different example. The lighting device 8 illustrated in FIG. 3 also comprises a support 10 which is attached to the reflector 9 and which is attachable to the connector 6 of the light bulb 5. The support 10 has in this case straight shape and extends along the longitudinal axis A.

The reflector 9 extends longitudinally along a path which is curved in three dimensions. Accordingly, the reflector 9 is made of one or more materials allowing it to be formed into a shape that is curved in three-dimensional space, including many metals and plastic materials. In this case, the path has the shape of a helix. The central axis of the helix coincides with the longitudinal axis A of the lighting device 8. The helix may of course be arranged differently in a different example. For instance, the central axis of the helix may be perpendicular to the longitudinal axis A. That is to say, the helix may be turned 90 degrees relative to the orientation shown in FIGS. 2 and 3. It should be noted that the path along which the reflector 9 extends may have a different shape. For example, the path may form some other type of spiral than a helix or the path may have a meander shape with, for example, at least three turns.

The reflector 9 here has a length lᵣ, a width wᵣ, and a height hᵣ. The length lᵣ may for example be at least 10 cm, alternatively at least 15 cm or at least 20 cm. The length lᵣ, the width wᵣ, and the height hᵣ may for example be such that lᵣ>20wᵣ and lᵣ>20 hᵣ, alternatively lᵣ>25wᵣ and lᵣ>25 hᵣ, or lᵣ>30wᵣ and lᵣ>30 hᵣ.

In this embodiment the reflector is arranged as a free-standing element and acts as a support for the filament in said reflector. This has the advantage that the lighting device does not require a separate support structure for the filament that is mechanically connected to the reflector.

As is best seen in FIG. 4, the reflector 9 here comprises a first wall 9a, a second wall 9b opposite to the first wall 9a, and a connecting wall 9c which connects the first and second walls 9a, 9b. The first and seconds walls 9a, 9b extend from the connecting wall 9c away from the longitudinal axis A. The orientation of the lighting device 8 is in this case such that the first wall 9a is located above the second wall 9b. The reflector 9 further has an inner surface 9d and an outer surface 9e. The part of the inner surface 9d that is on the connecting wall 9c faces away from the longitudinal axis A, and the part of the outer surface 9e that is on the connecting wall 9c faces towards the longitudinal axis A. The inner surface 9d is provided with a reflective coating. The reflective coating may, however, be omitted if the material of which the reflector 9 is made reflects light sufficiently well.

The reflector 9 further comprises a longitudinal groove 11. The longitudinal groove 11 is in this case arranged in a side of the reflector 9 that faces away from the longitudinal axis A. The surface of the groove 11 is in this case formed by the inner surface 9d of the reflector 9. Thus, the surface of the groove 11 is reflective. The groove 11 has a U-shaped transverse cross-section. The opening of the “U” is here directed in a direction that is non-perpendicular to the longitudinal axis A. More specifically, the opening of the “U” is directed away from the longitudinal axis A and slightly downwards. This arrangement promotes light emission away from the longitudinal axis A or, more specifically, to the side of the lighting device 5 and slightly downwards. By “to the side” or “straight to the side” is here meant perpendicularly to the longitudinal axis A. It should be noted that the cross-section of the groove 11 may have some other shape than a U-shape in a different example, such as a V-shape. Also, the open side of the groove 11 may be directed in a different direction than to the side and slightly downwards in order to promote light emission in a different direction, such as straight to the side or to the side and slightly upwards. Further, it should be noted that different longitudinal sections of the reflector 9 may be adapted to promote light in different directions. For example, the reflector 9 may have a bottom section adapted to promote light emission downwards, a middle portion adapted to promote light emission to the side and a top section adapted to promote light emission upwards. The lighting device 8 further comprises a light-emitting filament 12, henceforth referred to as the “filament” for brevity. The filament 12 is arranged in the groove 11 such that light emitted by the filament 12 is reflected by the reflector 9. The filament 12 extends longitudinally along the same path as the reflector 9.

The flexible filament can be wound around the groove of the reflector following the path of this groove over its longitudinal length.

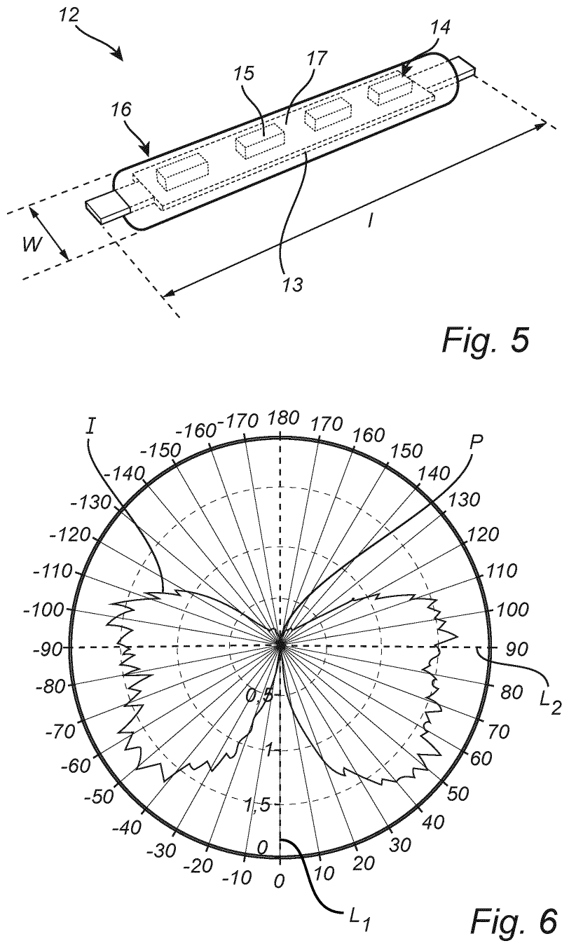

Thus, in this case, the filament 12 has the shape of a helix. The filament 12 is in this case of a conventional type known in the art and will be described in more detail with reference to FIG. 5 which schematically shows the filament 12 in a pre-bent state for purposes of greater clarity. During manufacturing of the lighting device 5, the filament 12 is bent to form the desired shape, which in this case is a helical shape.

The reflector 9 is arranged to support the filament 12 in said reflector 9. This has the advantage that the lighting device 8 does not require a separate support structure for the filament.

The filament 12 has a length l, a width w and a height h (not shown in FIG. 5). The length l may for example be at least 10 cm, alternatively at least 15 cm or at least 20 cm. The length l, the width w and the height h may for example be such that l>20w and l>20h, alternatively l>25w and l>25h or l>30w and l>30h.

The filament 12 comprises a carrier 13 which in this case is transparent. The carrier 13 comprises electrical circuitry (not shown), such as printed electrically conductive tracks.

Several solid-state light sources 14, henceforth referred to as the “light sources” for brevity, are mounted on the carrier 13. In this case, the light sources 14 form a single, straight row, although the light sources 14 may be arranged in some other manner in a different example, such as in a zigzag pattern. The light sources 14 are electrically connected to the electrical circuitry of the carrier 13. Each of the light sources 14 is configured to emit light from a light-emitting surface 15. The number of light sources 14 vary depending on for example the length l of the filament 12. The number of light sources 14 may for example be at least 20, alternatively at least 25, at least 30, or at least 40. Only four light sources 14 are illustrated in FIG. 4 for purposes of greater clarity. The light sources 14 are in this example light-emitting diodes (LEDs), so the filament 12 may be referred to as an LED filament. The LEDs may for example be semiconductor LEDs, organic LEDs or polymer LEDs. All of the light sources 14 are typically configured to emit light of the same color, although in some applications different light sources 14 may be configured to emit light of different colors.

The filament 12 further comprises an encapsulant 16. The encapsulant 16 typically comprises a polymer, such as a silicone-type of material. The encapsulant 16 covers the light-emitting surfaces 15. In a different example, the encapsulant 16 may cover only a part of the light-emitting surfaces 15. Further, in this case, the encapsulant 16 completely encloses the carrier 13. Thus, the encapsulant 16 is provided on the side of the carrier 13 where the light sources 14 are arranged as well as on the side of the carrier 13 where there are no light sources 14. It may be noted that, if the carrier 13 is not transparent, the encapsulant 16 is typically only provided on the side of the carrier 13 where the light sources 14 are arranged, although this may of course also be the case if the carrier 13 is transparent.

The encapsulant 16 comprises a translucent material 17. The translucent material 17 may for example be a polymer, such as a silicone material. The ability of silicone to withstand heat and light exposure makes it suitable to be used in LED filaments. In this case, the encapsulant 16 also comprises an optional luminescent material. The luminescent material may be an inorganic phosphor, an organic phosphor, quantum dots and/or quantum rods. The phosphor may for example be a blue, yellow/green, and/or orange/red phosphor. A blue phosphor may be used to convert UV light into blue light, a green/yellow phosphor may be used to convert UV and/or blue light into green/yellow light, and an orange/red phosphor may be used to convert UV, green/yellow, and/or blue light into orange/red light. The luminescent material is configured to at least partly convert light emitted by the light sources 14 to converted light. The converted light has a different wavelength than the light emitted by the light sources 14. In many applications, the converted light has a longer wavelength than the unconverted light. The unconverted light may for example be blue and/or violet, and the converted light may for example be green, yellow, orange and/or red.

It is noted that the encapsulant 16 may in a different example comprise a light scattering material in addition to or instead of the luminescent material. Examples of suitable light-scattering materials include: BaSO₄, TiO₂, Al₂O₃, silicone particles and silicone bubbles.

The color of the light emitted by the light sources 14 and the type of luminescent material depend on the application. For example, the luminescent material may be a phosphor and the light sources 14 may emit blue light and/or UV light which “pumps” the phosphor. Light sources 14 that are configured to emit red light are also used in some applications. Thus, in this case, the light emitted by the filament 12 comprises a mix of light converted by the luminescent material and non-converted light emitted by the light sources 14. Stated differently, the filament 12 is here configured to emit LED filament light which is a mix of LED light and converted LED light. The ratio between the converted light and the non-converted light depends on how much of the light emitted by the light sources 14 that is converted by the luminescent material. In some applications, the luminescent material and the color of the light emitted by the light sources 14 are chosen such that the filament 12 emits light that resembles the light emitted by an incandescent filament, i.e. yellow light. Alternatively, the filament 12 may be configured to emit white light. The white light may be light which is within 16 SDCM from the black body locus. The color temperature of such white light may for example be in the range from 2000 K to 6000 K, alternatively in the range from 2300 K to 5000 K or in the range from 2500 K to 4000 K. The color rendering index CRI of such white light may for example be at least 70, alternatively at least 80 or at least 85, such as 90 or 92.

It is noted that, in general, the light sources 14 may include UV LEDs, blue LEDs, and/or white LEDs, such as phosphor-converted LEDs, RGB LEDs, cool white and warm white LEDs.

Turning back to FIG. 3, it can be seen that the lighting device 8 further comprises a controller 18 electrically connected to the filament 12. The controller 18 may for example be configured to turn the filament 12 on or off, to vary the intensity of the light emitted by the filament 12, and/or to control the color of the light emitted by the filament 12. In this case, the controller 18 allows a user to control the filament 12 wirelessly, such as via a mobile phone or some other mobile device. It is noted that the controller 18 may have various positions in the light bulb 5 as long as it can receive wireless signals from external devices. Hence, the position should be such that the controller 18 is not screened by the connector 6 or some other component of the light bulb 5. It is noted that the controller 18 is an optional feature which may or may not be included in other examples of the lighting device 8.

During operation, power from the mains is supplied to the lighting device 8 via the connector 6 of the light bulb 5 and the connection 4 of the luminaire 1. The filament 12 emits light which is reflected by the reflector 9 and transmitted through the envelope 7 to illuminate the surroundings of the luminaire 1.

FIG. 6 illustrates schematically the distribution of the light emitted by the lighting device 8 in FIGS. 4 and 5 or differently stated, the emission pattern of the lighting device 8. The lighting device 8 is located at the center point P where the perpendicular lines L₁ and L₂ intersect. The line L₁ coincides with the longitudinal axis A of the lighting device 8. The curve I, which forms the two lobes in the diagram, represents the intensity of the emitted light in a plane which contains the longitudinal axis A, i.e. a section cut through the lighting device 8. The distribution of the light emitted by the lighting device 8 is here substantially rotationally symmetric around the longitudinal axis A. The distance from the center point P to a point on the curve I corresponds to a light intensity value (as measured in candela, for instance) in the given direction. Straight downwards and straight upwards correspond to 0 degrees and 180 degrees, respectively, and straight to the sides of the lighting device 8 correspond to the angles ±90 degrees. FIG. 6 shows that the lighting device 8 emits light mainly to the side and downwards.

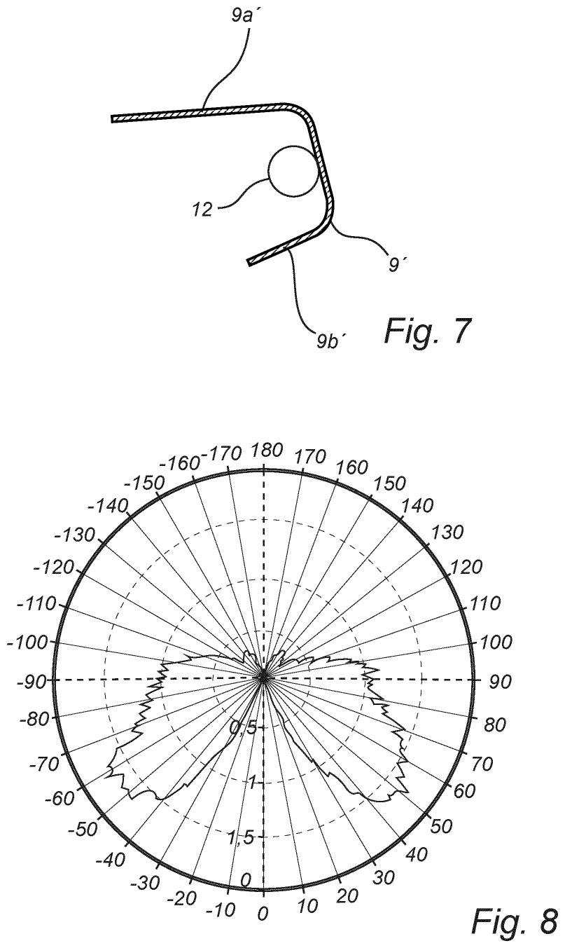

FIG. 7 shows a cross sectional view of a reflector 9′ which is similar to the reflector 9 of the lighting device 8 described above, except in that the first wall 9a′ is longer than the second wall 9b′. Thus, the two legs of the U-shaped cross section of the groove 11 have different lengths. The reflector 9′ is adapted to promote light emission downwards, i.e. in a direction away from the longer wall 9a′ or, differently stated, away from the longer leg of the U-shaped cross section.

FIG. 8 shows a light distribution diagram resulting from using the reflector 9 in FIG. 7 instead of the reflector 9 in FIG. 4. FIG. 8 shows that there is almost no light emitted in the upward direction.

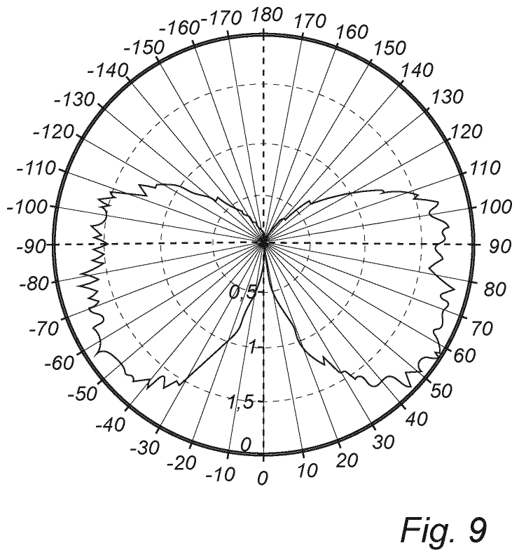

FIG. 9 shows a light distribution resulting from using a reflector which is similar to the reflector 9 of the lighting device 8 in FIG. 3, except in that the inner side 9d has been provided with a diffuse coating, such as a white coating, instead of a specular reflective coating. FIG. 9 shows that a less steep cut off is obtained.

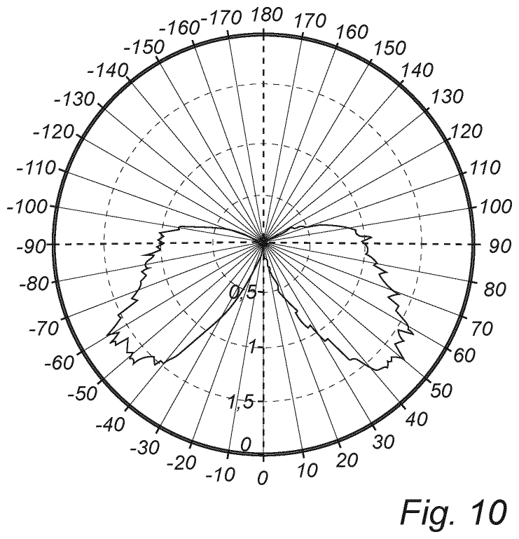

FIG. 10 shows a light distribution resulting from using a reflector which is similar to the reflector 9 of the lighting device 8 in FIG. 3, except in that the outer side 9e has been provided with a low-reflective coating, such as a black coating. Such a coating helps to increase the amount of light that is emitted straight to the sides of the lighting device, as shown in FIG. 10.

It may be noted that a specular reflector makes it possible to aim the light from the filament downward without hitting the reflector at a lower position on the outer surface (which will reflect it upwards). When using a diffuse reflector, it is difficult to avoid that some reflected light will hit a lower-positioned part of the outer surface, and that light is mostly directed upward and sideward. By making the outer surface low reflecting, this can be at least partially avoided as shown in FIG. 10.

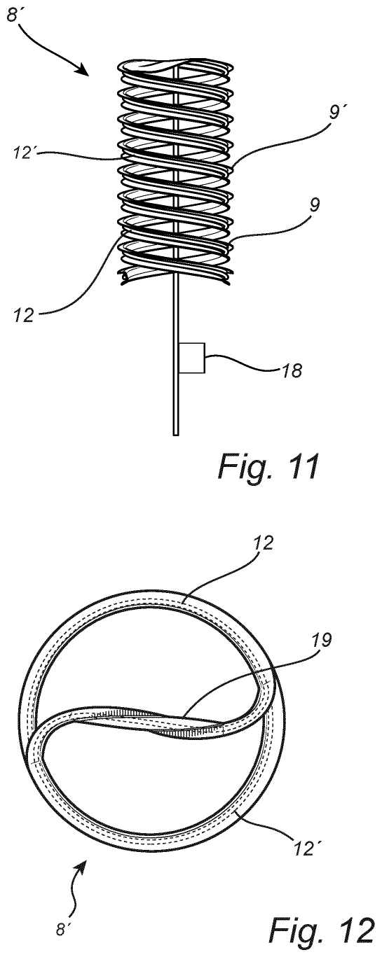

FIGS. 11 and 12 show a lighting device 8′ which is similar to the lighting device 8 in FIG. 3. However, the lighting device 8′ in FIG. 9 comprises two filaments 12, 12′ and two reflectors 9, 9′, each reflector 9, 9′ being arranged to reflect light emitted by one of the filaments 12, 12′. Each reflector 9, 9′ is similar to the reflector of the lighting device 8 in FIG. 3. The reflectors 9, 9′ are arranged so as to form two intertwined helices. The reflectors 9, 9′ are in this case connected at the top of the lighting device 8′ by a connecting member 19. The use of two reflectors 9, 9′ forming two intertwined helices helps to increase the homogeneity of the light emitted from the lighting device 8′. The connecting member 19 may for example have a twisted U-shape. Such a shape makes it possible to direct light downward or upwards, depending on the orientation of the U-shape.

The filaments 12, 12′ are in this case adapted to emit light of different color temperatures. The filaments 12, 12′ may be adapted to emit light of different colors, or light having same color or color temperature, in a different example. The controller 18 is typically configured to control the filaments 12, 12′ independently from each other and may, for example, be used to control the color temperature of the light emitted by the lighting device 8′.

It is noted a lighting device such as that in FIG. 8′ could also be configured to provide two different light distributions so that, for example, there is more light to the side or to the back. Further, a lighting device such as that in FIG. 8′ may be configured to provide a light distribution having a gradient that varies from top to bottom. The person skilled in the art realizes that the present invention by no means is limited to the preferred embodiments described above. On the contrary, many modifications and variations are possible within the scope of the appended claims. For example: the lighting device may comprise three or more reflectors, each reflector being adapted to reflect light from a filament; the lighting device may have two or more filaments arranged in the groove of the reflector; the filament may be fully recessed or semi-recessed in the reflector; one or both other ends of the filament may not be covered by the reflector; the lighting device may be configured to emit light, which has a first color temperature and a first spatial distribution, and light which has a second color temperature and a second spatial light distribution.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A lighting device comprising:
at least one light-emitting flexible filament comprising
an elongated carrier,
a plurality of solid-state light sources mounted on the carrier, wherein each solid-state light source is configured to emit light from a light-emitting surface, and
an encapsulant comprising a translucent material, wherein the encapsulant at least partially encloses the light-emitting surfaces of the solid-state light sources; and
an elongated reflector arranged to reflect light emitted by the light-emitting filament,
wherein the reflector is arranged as a free standing element and is provided with a longitudinal groove having a transverse cross section which is one of U-shaped, V-shaped, parabolic, circular and a combination thereof, or another suitable shape, said groove having an inner surface and an outer surface, wherein in which the flexible light-emitting filament is arranged in the groove such that the reflector acts as a support for the light-emitting flexible filament, and
wherein the reflector and the at least one light-emitting filament extend longitudinally along a common path, and wherein said path is curved in three dimensions.

2. The lighting device according to claim 1, wherein the lighting device has a longitudinal axis A, and wherein the lighting device is adapted to emit light rotationally symmetrically with respect to the longitudinal axis (A).

3. The lighting device according to claim 1, wherein the path has at least one of a spiral shape and a meander shape.

4. The lighting device according to claim 2, wherein the path has a spiral shape with a central axis extending along said longitudinal axis (A).

5. The lighting device according to claim 2, wherein the groove is arranged at a side of the reflector facing away from the longitudinal axis (A), whereby the reflector is adapted to promote light emission away from the longitudinal axis (A).

6. (canceled)

7. The lighting device according to claim 1, wherein two legs of the cross section have different lengths, whereby the reflector is adapted to promote light emission in a direction away from the longer leg.

8. The lighting device according to claim 1, wherein the cross section is open towards a direction which is non-perpendicular to the longitudinal axis (A), whereby the reflector is adapted to promote light emission in said direction.

9. The lighting device according to claim 1, wherein the reflector has a first longitudinal section adapted to promote light emission in a first direction, and a second longitudinal section adapted to promote light emission in a second direction different from the first direction.

10. The lighting device according to claim 8, wherein the first direction is parallel to the longitudinal axis (A), and wherein the second direction is perpendicular to the longitudinal axis (A) or is opposite to the first direction.

11. The lighting device according to claim 2, wherein a side of the reflector facing the longitudinal axis is provided with a low-reflective coating.

12. The lighting device according to claim 1, wherein the lighting device comprises two light-emitting filaments and two reflectors, and wherein the lighting device further comprises a controller configured to independently control the light emitted by the two light-emitting filaments.

13. A light bulb comprising:
at least one lighting device according to claim 1;
a light-transmissive envelope enclosing the at least one lighting device; and
a connector configured to mechanically and electrically connect the light bulb to a lightbulb socket.

14. A luminaire comprising:
at least one lighting device according to claim 1; and
a connection configured to supply power to the at least one lighting device.
